(19) United States
(12) Patent Application Publication
(10) Pub. No.: US 2008/0057230 A1
(43) Pub. Date: Mar. 6, 2008

(54) Coatings for Print Receptive Layers

(75) Inventors: Simon James Read, Mealsgate (GB); Eva Clorley, Wigton Cumbria (GB)

Correspondence Address: DLA PIPER US LLP;ATTN: PATENT GROUP, 500 8th Street, NW, WASHINGTON, DC, 20004-2131, US

(73) Assignee: INNOVIA FILMS LIMITED, Wigton, Cumbria (GB)

(21) Appl. No.: 11/719,069

(22) PCT Filed: Nov. 10, 2005
(86) PCT No.: PCT/EP05/55879

§ 371 Date: Sep. 6, 2007

(30) Foreign Application Priority Data
Nov. 10, 2004 (GB) 0424878.7

(51) Int. Cl. B41M 5/00; B41M 5/40

(52) U.S. Cl. 428/32.6; 428/336

(57) ABSTRACT

The invention provides a coating on a polymeric substrate forming a non-porous print receptive layer on the polymeric substrate, printability, thermal conductivity. Tg, surface hardness and surface smoothness of the print receptive layer being regulated by forming the print receptive layer from a dispersion containing a mixture of at least two acrylic latexes, at least one chosen to have an acid value of 20 to 60 mg KOH/g resin and a Tg less than 35 centigrade degrees, and at least one having a Tg greater than 90 centigrade degrees so as to adjust the hardness/Tg of the print receptive layer the acrylic polymer being present in each latex in the discontinuous phase so that the latexes are only partially miscible with one another, the dispersion further containing as essential components a metal containing cross linking agent to cross link the acrylic latexes and thereby further regulate both the thermal conductivity and the surface hardness of the print receptive layer, hollow polymeric particles to regulate the thermal conductivity of the print receptive layer and silica particles with a primary particle size of less than 100 nm to regulate the surface smoothness of the print receptive layer.

The present invention relates to a coating on a polymer film, the coating being provided to enable the coated film to be used as transfer imaging receiver sheet for thermal transfer printing and to receptor sheets for thermal transfer printing having improved resin receptivity for wider printing latitude, at higher speeds and lower print temperatures.

Thermal transfer printing employs a donor-sheet/receptor-sheet system, whereby a thermal print head applies heat to the backside of a donor-sheet in selective image wise fashion. The images are transferred to the receptor-sheet by mass transfer from the donor sheet.

It is well known in the prior art to employ thermal transfer techniques to print paper and other receptors. In the thermal transfer process, the paper sheet or other receptor is placed into contact with a ribbon bearing an ink, commonly a wax or wax/resin or resin ink. A laser or other heat source is applied to the ink bearing ribbon to heat the ink at selected locations and cause the transfer thereof to the receptor. The wax/ink mixture on the carrier ribbon melts or softens, preferentially adhering to the receptor sheet, which may be either paper or transparent film. In the case of paper, the acceptor sheet has more surface roughness than does the carrier, so ink transfer is largely achieved by a physical interlocking of the softened wax and ink with the paper fibres.

Conventional coated receptor sheets have caused some difficulties in the printing operation particularly in regard to ink transfer from the ribbon. Many conventional coated thermal printing receptor sheets are characterized by their failure to provide good printing results at reduced heat settings. Reduced heat provides greater print head life and allows printing at increased speeds.

The present invention includes coated receptor materials that provide excellent printability and high printing speeds when low heat settings are employed at the print head. The coating is such that it functions as an insulating layer to reduce the rate at which the heat is transferred away from the ribbon during printing. While it is known generally in the prior art to utilize insulating layers in coated printing papers, there is no teaching of the use of the specific coating disclosed herein for coating polyolefin films which is particularly appropriate for thermal transfer printing techniques to provide a coating on a thermal transfer receptor sheet giving excellent printability with significantly reduced coat weights.

The coating is designed to give optimum receptivity to resin and wax/resin inks typically used to thermally print on various substrates. In the fraction of a second that the molten ink is in contact with the coating, it must wet and attach to the coating or it will be pulled away by the ribbon as it breaks contact with the coating, resulting in skips in the print. This requires that the ink wet and penetrate the coating surface and adhere well enough to resist the force pulling it away from the coating.

The surface of the receptor sheet must be smooth enough so that the recorded images are clear and the occurrence of missing and/or partial ink dots is minimised but not so smooth that the printed ink images are not sufficiently anchored or fixed to the surface coating. The above-mentioned phenomena cause a decrease in the dot reproducibility. Beside the increase in the colour density of the recorded images due to the low dot reproducibility sometimes a decrease in colour density of the recorded images occurs due to a low adsorption of the ink by the hot melt ink-receiving layer.

The heat-insulating property is also an important physical property of the receptor sheet, if the heat-insulating property of the recording sheet is too low (in other words, if the thermal conductivity of the receptor sheet is too high), the temperature of the interface portion between the ink ribbon and the recording sheet brought into contact with the ink ribbon cannot be raised to a level where the ink image transfers satisfactorily to the ink-receiving layer. It is necessary to avoid a thermal conductivity that can result in heat being dissipated from the printer head without transfer of an ink image.

Because of the capability of forming images by simple application of heat, thermal receptor materials are widely used with thermal printers for recording output information from computers, facsimile apparatus, telex, cash receipts, cash registers, and other information transmission and measuring instruments. Thermal receptor materials can be formed into adhesive labels and can be imprinted with a bar code which when scanned will identify the object to which the code is applied.

The high contrast normally associated with thermal transfer printing enables such adhesive labels to be utilized in high-speed sorting as the PCS (print contrast signal) is usually high when printed on a white substrate.

A high Print Contrast Signal (PCS) image greatly enhances reliable high-speed readability with a high percentage of accuracy in detecting the imaged areas when optical or electronic decoding devices and scanners are utilized. These imaged areas can be subsequently scanned in the ranges of 380 to 4000 nanometres using visible laser diode (VLD), light emitting diode (LED) scanners, as well as charge-coupled device (CCD) cameras. Uses include, but are not limited to applications such as airline baggage tags, laminated durable labels for general laboratory uses applications, ultraviolet thermal imaging durable labels, or durable labels for use on returnable totes or shipping containers. Such labels are often referred to as variable printed information labels.

According to the invention there is provided a coating on a polymeric substrate forming a non-porous print receptive layer on the polymeric substrate, printability, thermal conductivity, Tg, surface hardness and surface smoothness of the print receptive layer being regulated by forming the print receptive layer from a dispersion containing a mixture of at least two acrylic latexes, at least one chosen to have an acid value of 20 to 60 mg KOH/g resin and a Tg less than 35 centigrade degrees, and at least one having a Tg greater than 90 centigrade degrees so as to adjust the hardness/Tg of the print receptive layer the acrylic polymer being present in each latex in the discontinuous phase so that the latexes are only partially miscible with one another, the dispersion further containing as essential components a metal containing cross linking agent to cross link the acrylic latexes and thereby further regulate both the thermal conductivity and the surface hardness of the print receptive layer, hollow polymeric particles to regulate the thermal conductivity of the print receptive layer and silica particles with a primary particle size of less than 100 nm to regulate the surface smoothness of the print receptive layer.

The invention also includes coated receptor sheets made from webs coated with the coating of the present invention.

The coating is based on the use of acrylic emulsion latexes of the kind where the polymers present are in a discontinuous phase and are discrete from one another. This occurs when two or more latexes are used and are not completely miscible. This we believe further results in the particles in the latexes with a high acid value tending to concentrate near or at the surface of the resultant dried coating in which they are incorporated while the particles in latexes chosen because of their Tg concentrate within the coating and make a major contribution to the bulk hardness of the coating.

The dispersions of polymer particles used in this invention are latexes or polymers of acrylic materials that are stable in a water-based medium. Such polymers are generally classified as addition polymers. Such latex polymers can be prepared in aqueous media using well-known free radical or redox emulsion polymerization methods and may consist of homopolymers made from one type of monomer or copolymers made from more than one type of monomer. Polymers comprising monomers which form water-insoluble homopolymers are preferred, as are copolymers of such monomers. Preferred polymers may also comprise monomers which give water-soluble homopolymers, if the overall polymer composition is sufficiently water-insoluble to form lattices. The dispersion in accordance with the invention should contain at least one cross linking agent for cross linking the acrylic polymer present. This may well, as is known, improve the adhesion of the receptive layer to the substrate but more importantly we have now found where the cross linking agent is one containing polyvalent metal cations that it assists in regulating the thermal conductivity of the receptive surface. The cross linker may be added to the mixture of water-dispersible components.

We have found that the combination of a metal cross linking agent such as zirconium ammonium carbonate (This material is available under the trade name Bacote 20 from Magnesium Electron Ltd of Swinton Manchester) and hollow polymeric particles such as those formed from a styrene acrylic polymer and sold under the trade name Ropaque in the coating composition enables a coating to be formulated with a thermal conductivity which is at the right level to achieve a satisfactory print receptive surface.

The upper and lower limits for the amount of cross linker will be related to the actual latexes used and can be easily determined by experiment. It is important to avoid the situation where the amount of cross linker causes so much cross linking that the adhesion of the coating to the substrate is lost.

It is also important to regulate the quantity of the hollow polymeric particles present so that the surface is smooth enough to achieve a satisfactory print receptive surface, and sufficient is present that in combination with the quantity of the metallic cross linking agent used achieves the level of heat insulation giving satisfactory print quality.

EP0300505B1 discloses the use of such hollow particles in an intermediate layer of a multilayer coating for thermal transfer printing to modify the heat transfer properties of a receptor sheet but there is no disclosure of the use in a single layer in combination with a polyvalent metal containing cross linking agent and a film formed as disclosed herein from a dispersion containing a combination of at least two acrylic latexes chosen for their particular characteristics.

The preferred hollow polymeric spheres are those sold under the trade name Ropaque Ultra which is a hollow sphere plastic pigment from Rohm & Haas. The hollow spheres have a particle size of 0.4 μm with a shell thickness of 0.06 μm and contain 55% void volume.

Ropaque® opaque polymers are non-film-forming synthetic pigments engineered to provide dry hiding in water-based paints. They consist of spherical styrene/acrylic beads supplied as emulsions. In wet paints the beads are filled with water. As the paints dry, water permanently diffuses from the centre of the beads and is replaced by air, resulting in discrete encapsulated air voids uniformly dispersed throughout the dry paint film.

We prefer to use hollow plastic spheres have a particle size of 0.1 to 30 μm or 0.1 to 20 μm which contain 30 to 60% void volume.

When the size is less than 0.1 micrometer, satisfactory heat-insulating effects cannot be expected. Over 20 or in some cases 30 micrometers, the smoothness of the image-receiving layer lowers and the resulting lower contact with the delivering ink ribbon reduces ink receptivity. In order to ensure that the coating has the required surface smoothness, it has been found essential to include in the coating composition, silica particles. We prefer to use a nano silica with a primary particle size of less than 100 nm. We measure surface smoothness by using Ra values.

The smoothness of a coated receptor sheet according of the invention may be determined using a Surtronic 10 or Talisurf. We prefer to achieve a smoothness with an Ra of less than about 40 μm and preferably less than about 15 μm.

The dispersion used to coat the polyolefin substrates should contain about 15-25% solids in order to achieve satisfactory film forming properties. The film formed should be uniform and continuous. A solids content below 10% will result in missing coating and greater than 25% will increase roughness and the chance of cohesive failure.

In order to reduce the sliding friction of the print receptive coating in accordance with this invention, lubricants liquid paraffin and paraffin or wax like materials such as carnauba wax, natural and synthetic waxes, petroleum waxes, mineral waxes, silicone-wax copolymers and the like may be included in the dispersion. We prefer to incorporate about 2% by weight of dry solids in the dispersions of the invention of carnauba or polyethylene wax.

The dispersion is coated on to the surface of the chosen web and dried using any conventional technique. The coating composition of the invention can be applied by any of a number of well known techniques, such as dip coating, rod coating, blade coating, air knife coating, gravure coating and reverse roll coating, extrusion coating, slide coating, curtain coating, and the like. After coating, the layer is generally dried by simple evaporation, which may be accelerated by known techniques such as convection heating. The dispersion is preferably applied using a gravure process and the drying step carried out in an oven. The drying of the coated dispersion removes water from the dispersion leaving a uniform continuous film with any non film forming particles dispersed in the film.

The coating is preferably applied so as to have a coating weight on drying of between 0.5 and 1.40 grams per meter squared preferably about 1 gram per meter squared.

A conventional thermal recording print receptive material comprises a support material made of, for example, a sheet of ordinary paper, synthetic paper, or a resin film provided with a print receptive coating.

Polyolefins which may be used as the support material comprise polyethylene, polypropylene, mixtures thereof, and/or other known polyolefins. The polymeric support material may be a film or sheet and can be made by any process known in the art, including, but not limited to, cast sheet, cast film or blown film. The film or sheet may be of monolayer or of multi-layer construction. Our invention is particularly applicable to where the support material comprises a cavitated or non-cavitated polypropylene film with a polypropylene core and skin layers with a thickness of about 60 μm formed for example from copolymers of ethylene and propylene or terpolymers of propylene, ethylene and butylene.

The polyolefin surface to receive the print receptive coating before coating is primed by applying a conventional primer coating containing a polyethyleneimine. We prefer to use MICA (PEI) (available from Mica Corporation) which is applied at 0.04 grams per square meter from a water solution of 5% solids.

The following examples, in which all parts are parts by weight, illustrate but do not limit the invention:

### EXAMPLES 1-10

The method followed in preparing the coating dispersions used to form the coating of the invention exemplified in Example 1 was as follows:

1) 2.98 Kg Carboset 2732 was mixed with 2.75 Kg Carboset 1087.

Carboset 2732 is an acrylic latex with an acid value of 50 mg of KOH/g of resin, and a Tg of 21° C.

Carboset 1087 is an acrylic latex which has a Tg of 105° C.

0.06 Kg of TiO₂ was then added to this admixture and mixed using a rotastator mixer. 0.22 Kg Lanco Glidd, 2.67 Kg Bindzil 15/500 and 0.4 Kg Bacote 20 were then added and stirred in using a paddle stirrer. 2.22 Kg Ropaque Ultra was then added slowly whilst still stirring. 0.26 Kg Ebecryl 1160 Emulsion and Water (8.43 Kg) were also added. The emulsion of Ebecryl 1160 was made previously by adding Ebecryl 1160 to an equivalent amount of water and 1% Dowfax surfactant under high shear for one hour.

The coating solids were adjusted by addition of water to 20%, i.e. 80% water. A polypropylene film primed with a polyethyleneimine polymer, was coated with the dispersion. The coating was dried to a final coat weight of 1 gram per meter squared.

The same protocol was used to make the coating dispersions of Examples 2 to 10. It will be apparent that other protocols may also be suitable for making coating dispersions for use in forming the coatings of the invention.

Table 1 gives the composition of each of ten batches of coating dispersions, numbered 1 to 10 as mixed for coating, and 1a to 10a as the dry solids content that is the eventual content of the dried coating on the coated film.

TABLE 1

| Components | 1 | 1a | 2 | 2a | 3 | 3a | 4 | 4a |
|---|---|---|---|---|---|---|---|---|
| Carboset 2732 | 2.98 | 33.50 | 2.89 | 32.50 | 2.93 | 33.0 | 3.77 | 33.9 |
| Carboset 1087 | 2.76 | 33.50 | 2.68 | 32.50 | 2.72 | 33.0 | 3.49 | 33.9 |
| Ropaque Ultra | 2.22 | 15.00 | 2.22 | 15.00 | 2.22 | 15.0 | 2.41 | 13.0 |
| Lanco Glidd TD | 0.22 | 1.40 | 0.22 | 1.40 | 0.24 | 1.5 | 0.40 | 2.0 |
| Bindzil 15/500 | 2.67 | 10.00 | 2.67 | 10.00 | 2.67 | 10.0 | 3.33 | 10.0 |
| TiO₂ | 0.06 | 1.40 | 0.06 | 1.40 | 0.06 | 1.5 | 0.10 | 2.0 |
| Bacote 20 | 0.40 | 2.00 | 0.80 | 4.00 | 0.40 | 2.0 | 0.50 | 2.0 |
| Ebecryl 160 | 0.26 | 3.20 | 0.26 | 3.20 | 0.32 | 4.0 | 0.32 | 3.2 |
| Water | 8.43 | | 8.21 | | 8.44 | | 5.68 | |
| Solids | 20.00 | | 20.00 | | 20.00 | | 20.00 | |

| Components | 5 | 5a | 6 | 6a | 7 | 7a |
|---|---|---|---|---|---|---|
| Carboset 2732 | 3.72 | 33.5 | 3.89 | 35.0 | 6.29 | 56.58 |
| Carboset 1087 | 3.45 | 33.5 | 3.61 | 35.0 | 0.53 | 5.18 |
| Ropaque | 1.85 | 10.0 | 1.85 | 10.0 | 1.72 | 9.30 |
| Lanco Glidd TD | 0.28 | 1.4 | 0.00 | 0.0 | 0.57 | 2.87 |
| Bindzil 15/500 | 5.00 | 15.0 | 0.00 | 0.0 | 5.58 | 16.74 |
| TiO₂ | 0.07 | 1.4 | 0.00 | 0.0 | 0.02 | 0.36 |
| Bacote 20 | 0.50 | 2.0 | 2.50 | 10.0 | 2.24 | 8.97 |
| Ludox X30 | 0.00 | 0.0 | 1.67 | 10.0 | | |
| Ebecryl 160 | 0.32 | 3.2 | 0.00 | 0.0 | 0.00 | 0.00 |
| Water | 4.80 | | 11.48 | | 10.59 | |
| Solids | 20.00 | | 20.00 | | 17.00 | |
| Components | 8 | 8a | 9 | 9a | 10 | 10a |
| Carboset 2732 | 3.11 | 32.0 | 6.61 | 70.0 | 5.67 | 60.0 |
| Carboset 1087 | 2.89 | 32.0 | 0.22 | 2.5 | 1.10 | 12.5 |
| Ropaque Ultra | 1.62 | 10.0 | 1.18 | 7.5 | 1.18 | 7.5 |
| Lanco Glidd TD | 0.00 | 0.0 | 0.34 | 2.0 | 0.34 | 2.0 |
| Bindzil 15/500 | 0.00 | 0.0 | 2.27 | 8.0 | 2.27 | 8.0 |
| TiO₂ | 0.00 | 0.0 | 0.09 | 2.0 | 0.09 | 2.0 |
| Bacote 20 | 3.50 | 16.0 | 1.70 | 8.0 | 1.70 | 8.0 |
| Ebecryl 160 | 0.00 | 0.0 | 0.00 | 0.0 | 0.00 | 0.0 |
| Ludox X30 | 1.46 | 10.0 | 0.00 | 0.0 | 0.00 | 0.0 |
| Water | 12.42 | | 12.60 | | 12.67 | |
| Solids | 17.50 | | 17.00 | | 17.00 | |

The coating compositions 1 to 10 were applied to commercially available polypropylene films, and receptor sheets formed from the films were thermal transfer printed with a resin ribbon, and the quality gradings are given in Table 2, in which coat weights are expressed in gm².

The ribbon used was a Sony 5075 and the printer a Zebra 140IIIi Plus. The print speed was 6 inches (12 cm) per second. Print quality was graded visually on a scale of A to F. The lowest heat setting at which the greatest amount of ink is laid down is given a grade A. The machine had heat settings from 0 to 30, and on this machine, grade A was achieved at a heat setting of 10.

It was found necessary to use a much higher heat setting of 15 to achieve A grade print quality with a commercially available receptor sheet sold under the trade description YUPO SGS 85.

TABLE 2

| Base Film Coated | Coating Used | Coat Weight | Print Quality |
|---|---|---|---|
| WGS92 white film | Example 1 | 1.70 | C |
| WGS92 white film | Example 1 | 1.50 | D |
| WGS92 white film | Example 1 | 1.40 | C |
| WGS92 white film | Example 2 | 1.20 | B |
| WGS92 white film | Example 5 | 1.30 | D |
| WGS92 white film | Example 3 | 1.47 | C |
| WGS92 white film | Example 4 | 1.20 | B |
| WGS92 white film | Example 1 | 3.00 | F |
| WGS92 white film | Example 1 | 2.90 | F |
| WGS92 white film | Example 2 | 2.86 | B |
| AWPA 60 white film | Example 3 | 2.86 | E |
| AWPA 60 white film | Example 4 | 2.53 | F |
| AWPA 60 white film | Example 5 | 2.53 | F |
| TC36 65 | Example 5 | 2.70 | D |
| C50 | Example 6 | 1.00 | D |
| TB2264 cavitated | Example 7 | 1.50 | B |
| TB2264 cavitated | Example 7 | 1.00 | A |
| C50 | Example 8 | 1.00 | A |
| C50 | Example 9 | 1.00 | A |
| C50 | Example 10 | 1.00 | A |

Acceptable print quality is achieved with grades A to C. D to F is unsatisfactory. We believe that values of D, E and F are mostly caused by using higher coat weights on certain types of film. Higher coat weights (above 1.4 or 1.5 gm² for example) appear to be satisfactory in some films, but in most cases a lower coat weight (below 1.4 or 1.5 gm² for example) appears to be more satisfactory. It should also be appreciated that print quality may be affected by other factors, such as irregularities in the film being coated, or the presence of dust on the coated surface. Thus, unsatisfactory results may in some cases bear repetition to obtain satisfactory results.

In the above examples:

Ebecryl 1160 is the purified triacrylate of ethoxylated trimethylol propane supplied by Surface Specialities of Drogenbos Belgium.

Lanco Glid TD is a fine ground dispersion of low molecular weight polyethylene wax in isopropanol (the wax content is 25.0%+ or −1%) and is supplied by Capricorn Chemicals Cambridgeshire UK

Carboset XPD 1087 is a styrene-acrylic copolymer emulsion containing 49% polymer solids in water with 1.1% ammonia supplied by BF Goodrich Chemical Spain Barcelona Spain

Carboset XPD 2732 is an acrylic copolymer emulsion containing 45% solids in water and is supplied by BF Goodrich Cleveland Ohio USA.

Ropaque Ultra is a hollow spherical polymeric pigment formed from a styrene acrylic copolymer and is supplied as a dispersion containing 29-31% of the copolymer material in water and is available from Rohm and Haas (UK) Croydon CR9 3NB UK.

Binzil 15/500 is a colloidal dispersion of discrete spherical silica particles in weakly alkaline water and is available from EKA Chemicals AB Colloidal Silica Group SE-446-80 Bohus Sweden.

WGS92 is a two side coated high gloss biaxially oriented polypropylene film available from Innovia Films Ltd, Wigton, Cumbria CA7 9BG, United Kingdom under the trade mark Rayoart.

AWPA 60 is a two side coated high gloss biaxially oriented polypropylene film available from Innovia Films Ltd, Wigton, Cumbria CA7 9BG, United Kingdom under the trade mark Rayoface.

TC36 65 is a cavitated oriented polypropylene film available from Innovia Films Ltd, Wigton, Cumbria CA7 9BG, United Kingdom.

TB2264 is a cavitated oriented polypropylene film available from innovia Films Ltd, Wigton, Cumbria CA7 9BG, United Kingdom.

C50 is an oriented polypropylene film available from Innovia Films Ltd, Wigton, Cumbria CA7 9BG, United Kingdom.

1. A coating for forming a non-porous print receptive layer on a said coating is formed from a dispersion containing a mixture of at least two acrylic latexes, at least one having an acid value of 20 to 60 mg KOH/g resin and a Tg less than 35° C., and at least one having a Tg greater than 90° C. so as to adjust the hardness/Tg of the print receptive layer the acrylic polymer being present in each latex in the discontinuous phase so that the latexes are only partially miscible with one another, a metal containing cross linking agent to cross link the acrylic latexes, hollow polymeric particles to regulate the thermal conductivity of the print receptive layer, and silica particles with a primary particle size of less than 100 nm to regulate the surface smoothness of the print receptive layer.

2. A coating according to claim 1 wherein the hollow polymeric particles are spherical styrene/acrylic beads.

3. A coating according to claim 2 wherein the beads have a particle size in the range 0.1 to 30 μm.

4. A coating according to claim 1 having a surface smoothness with an Rₐ less than 40 μm.

5. A coating according to claim 4 wherein the surface smoothness has an Rₐ less than 15 μm.

6. A coating according to claim 1, wherein the dispersion used to form the coating has a solids content in the range about 10% to 30%.

7. A coating according to claim 6 wherein the dispersion used to form the coating has a solids content in the range of 15% to 25%.

8. A coating according to claim 6 applied so that after drying, a coating weight in the range 0.3 to 1.8 gm-2 is achieved.

9. A coating according to claim 8 coating applied so that after drying, a coating weight in the range 0.4 to 1.65 gm⁻² is achieved.

10. A coating according to claim 9 applied so that after drying, a coating weight in the range of 0.4 to 15 gm⁻² is achieved.

11. A coating according to claim 1 wherein the metal containing cross-linking agent is a zirconium based cross-linking agent.

12. A coating according to claim 11 wherein the metal containing cross-linking agent is zirconium ammonium carbonate.

13. A thermal recording print receptive material coated with a coating according to claim 1, wherein the polymeric substrate on which the nonporous print receptive layer has been formed is a multilayer film.

14. A material according to claim 13 wherein the multilayer film comprises a polypropylene core and skin layers formed from copolymers of ethylene and polypropylene or terpolymers of propylene, ethylene and butylenes.

15. A thermal recording print receptive material according to claim 13, wherein the multilayer film is a cavitated film.

16. The coating according to claim 2 having a surface smoothness with an Rₐ less than 40 μm.

17. The coating according to claim 2, wherein the dispersion used to form the coating has a solids content in the range about 10% to 30%.

18. The coating according to claim 2, wherein the metal containing cross-linking agent is a zirconium based cross linking agent.

19. A thermal recording print receptive material coated with a coating according to claim 2, wherein the polymeric substrate on which the nonporous print receptive layer has been formed is a multilayer film.

20. The thermal recording print receptive material according to claim 14, wherein the multilayer film is a cavitated film.
